(19) United States
(12) Patent Application Publication
(10) Pub. No.: US 2019/0050132 A1
(43) Pub. Date: Feb. 14, 2019

(54) VISUAL CUE SYSTEM

(71) Applicant: HEWLETT-PACKARD DEVELOPMENT COMPANY, L.P., Houston, TX (US)

(72) Inventors: Scott RAWLINGS, Fort Collins, CO (US); Ian N. ROBINSON, Palo Alto, CA (US); Hiroshi HORII, Palo Alto, CA (US); Robert Paul MARTIN, Fort Collins, CO (US); Nelson L. CHANG, Palo Alto, CA (US); Arun Kumar PARUCHURI, Palo Alto, CA (US)

(73) Assignee: HEWLETT-PACKARD DEVELOPMENT COMPANY, L.P., Houston, TX (US)

(21) Appl. No.: 16/075,607

(22) PCT Filed: Oct. 11, 2016
(86) PCT No.: PCT/US2016/056452

§ 371 Date: Aug. 4, 2018

(51) Int. Cl. G06F 3/0481; G06F 3/0354

(52) U.S. Cl. CPC G06F 3/04812; G06F 2203/04804; G06F 3/03545

(57) ABSTRACT

A visual cue system includes an input device, and a display device communicatively coupled to the input device to present a representation of the input device and a representation of a hand of a user of the input device as the user moves the input device and the user's hand. The representation of the hand of the user provides a visual cue to the user.

### BACKGROUND

In electronic devices such as computers, smart phones, tablets and others, an input device may be used to provide data and control signals to a processing device of the electronic device. An input device may be any peripheral piece of computer hardware equipment such as keyboards, mouse, digital pens, touch screen devices, scanners, digital cameras, and joysticks.

### BRIEF DESCRIPTION OF THE DRAWINGS

The accompanying drawings illustrate various examples of the principles described herein and are a part of the specification. The illustrated examples are given merely for illustration, and do not limit the scope of the claims.

FIG. 1 is a block diagram of a visual cue system, according to one example of the principles described herein.

FIG. 2 is a diagram of a visual cue system, according to another example of the principles described herein.

FIG. 3 is a block diagram of the visual cue system of FIG. 2, according to one example of the principles described herein.

FIG. 4 is a diagram of a visual cue system, according to yet another example of the principles described herein.

FIG. 5 is a block diagram of the visual cue system of FIG. 4, according to one example of the principles described herein.

FIG. 6 is a flowchart depicting a method presenting a visual cue, according to one example of the principles described herein.

FIG. 7 is a flowchart depicting a method presenting a visual cue, according to another example of the principles described herein.

FIG. 8 is a flowchart depicting a method presenting a visual cue, according to yet another example of the principles described herein.

Throughout the drawings, identical reference numbers designate similar, but not necessarily identical, elements.

### DETAILED DESCRIPTION

An input of the input device may be performed on a surface or plane other than a plane on which the output is perceived by a user. In the case where the input device is a pen, this type of input arrangement may be referred to as indirect pen input where the input surface and the display on which the output is presented are physically separate from one another and a user senses a loss of direct hand-eye coordination. For example, a user may be writing or drawing on a tablet device or surface that is located on a horizontal plane, and the output of that action may be displayed on a separate display device that is not parallel to the tablet device or surface, but is, instead, angled with respect to that horizontal plane.

In other words, the surface at which the user interacts and provides input is different from the surface used to output a visual representation of that input. The loss of direct hand-eye coordination in an indirect input system may also be experienced in an augmented reality (AR) or virtual reality (VR) systems. Still further, direct hand-eye coordination may be further diminished if either or both of the input and output surfaces have different geometries relative to one another or relative to, for example, a flat surface. The interaction or input surface may differ from the visual or output surface with regard to coordinate plane locations, shapes, sizes, geometries, volumes, or other aspects such that input to one surface and visualization at another surface diminishes a user's ability to coordinate their hands and eyes sufficiently to appreciate the coordination between inputs and outputs. This lack of coordination experienced by a user may occur in connection with flat surfaces such as flat display devices and flat input surfaces, in connection with curved surfaces such as curved display devices and uneven, non-flat input surfaces, and in the case of AR and VR systems where the input surface is any plane within a volume of space.

Many users may be frustrated by the non-intuitive nature of creating, editing, or annotating content on one surface and seeing an output appear on a second surface. From the user's perspective, the action of writing or drawing on one surface and seeing the output on a display device that is located on a separate plane may be awkward, and may result in an inferior rendering of the subject matter the user is writing or drawing. For example, a user's handwriting may not be a recognizable or a drawing may be less precise as compared to when a user is writing on one surface and the output is rendered on the same surface.

The reason for this imprecision in writing or drawing in this type of environment may be due to a lack of a visual cue. Visual cues provide the user with an idea as to where the user's hand, writing instrument, or combinations thereof are located within the output device such as a display device. The examples described herein provide a visual representation of an input device such as a stylus or smart pen, a visual representation of a user's hand and/or arm, or combinations thereof that are overlaid on an output display image presented on an output device such as a display device. The visual representations of the input device and the user's hand and/or arm act as a guide for the user to orient his or her hand and the input device, and have recognizable and realistic visual feedback. The visual cue systems and methods described herein may also be used in augmented reality and virtual reality environments where the pen input is used to draw in space, either via a tablet surface, or in free space. The examples described herein not only make the experience of indirect pen input easier for novices to grasp, expert draftsmen may also benefit from a better ability to plan pen motions based on pen orientation and hand/arm pose.

Direct input refers to input of an input device being performed on the same surface or plane as the plane on which the output is perceived by a user. For example, a digitizer may be built into a display device such that the input surface and the display device are the same surface. However, this arrangement is not so ergonomically optimal as the user may tend to hunch over their work. Further, the user may not be able to see the entirety of the output since the user cannot see through his or her hand. Thus, in one example, the visual cues described herein may be made semitransparent as displayed on a display device so that an entirety of the user's input may be viewed on the display device.

Examples described herein provide a visual cue system. The visual cue system includes an input device, and a display device communicatively coupled to the input device to present a representation of the input device and a representation of a hand of a user of the input device as the user moves the input device and the user's hand. The representation of the hand of the user provides a visual cue to the user. In one example, the input device includes a smart pen, and a substrate comprising elements recognizable by the smart pen to identify position and orientation of the smart pen with respect to the substrate. The representation of the hand of the user is presented based on an orientation of the input device and the position of the input device relative to a substrate. The input device communicates the orientation and position information to the display device. The representation of the hand of the user is presented on the display device as a shadow hand. The shadow hand is represented based on orientation and position information obtained by the input device.

In another example, the input device includes a stylus, and a tablet device communicatively coupled to the display device. The visual cue system further includes an image capture device to capture an image of the hand of the user. The representation of the hand of the user presented on the display device includes a video overlay of the user's hand.

In both of the above cases, the representation of the hand of the user is rendered at least partially transparent to not occlude objects displayed on the display device. A degree of transparency of the representation of the hand of the user is user-definable.

Examples described herein also provide an indirect input user interface for presenting visual cues. The indirect input user interface includes an input surface, and an input device to interact with the input surface. The interaction between the input device and the input surface defining an orientation and a position of the input device with respect to the input surface. The indirect input user interface also includes a display device communicatively coupled to the input device and the input surface. The display device presents a representation of the input device and a representation of a hand of a user of the input device as the user moves the input device and the user's hand, the representation of the hand of the user providing a visual cue to the user. Input to the input surface is performed on a different visual plane relative to a visual plane of the display device. The representation of the hand of the user is rendered at least partially transparent to not occlude objects displayed on the display device.

Examples described herein further provide a computer program product for presenting a visual cue. The computer program product includes a non-transitory computer readable medium including computer usable program code embodied therewith. The computer usable program code, when executed by a processor, identifies an orientation and a position of an input device with respect to an input surface, and displays on a display device a representation of the input device and a representation of a hand of a user of the input device as the user moves the input device and the user's hand. The representation of the hand of the user provides a visual cue to the user. The computer program product further includes computer usable program code to, when executed by the processor, calibrate movement of the input device. The computer program product further includes computer usable program code to, when executed by the processor, scale the representation of the hand of the user to display. The computer program product further includes computer usable program code to, when executed by the processor, detect a hover state of the input device above an input surface, and represent the hover state of the input device on the display device.

As used in the present specification and in the appended claims, the term “a number of” or similar language is meant to be understood broadly as any positive number comprising 1 to infinity; zero not being a number, but the absence of a number.

In the following description, for purposes of explanation, numerous specific details are set forth in order to provide a thorough understanding of the present systems and methods. It will be apparent, however, to one skilled in the art that the present apparatus, systems, and methods may be practiced without these specific details. Reference in the specification to “an example” or similar language means that a particular feature, structure, or characteristic described in connection with that example is included as described, but may not be included in other examples.

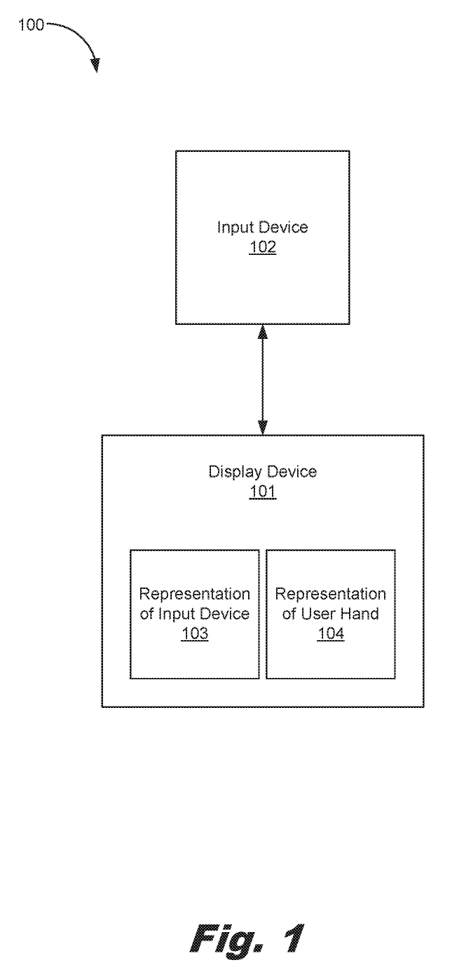

Turning now to the figures, FIG. 1 is a block diagram of a visual cue system (100), according to one example of the principles described herein. The visual cue system includes an input device (102), and a display device (101) communicatively coupled to the input device (102) to present a representation of the input device (103) and a representation of a hand of a user of the input device (104) as the user moves the input device (102) and the user's hand. In this manner, the representation of the input device (103), the hand of the user (104), or combinations thereof provide a visual cue to the user as the user views the display device (101).

The input device (102) may be any device used to input information to the visual cue system (100). Further, the display device (101) may be any device used to output a representation of the user's input. In one example, the input device (102) may be a smart pen, and the output device (101) may be a computer device-driven display device. In this example, the smart pen may relay position and orientation information to the computer device that drives the display device, and the representation of the input device (103), the hand of the user (104), or combinations thereof may be displayed on the display device (101) based on the information relayed by the smart pen.

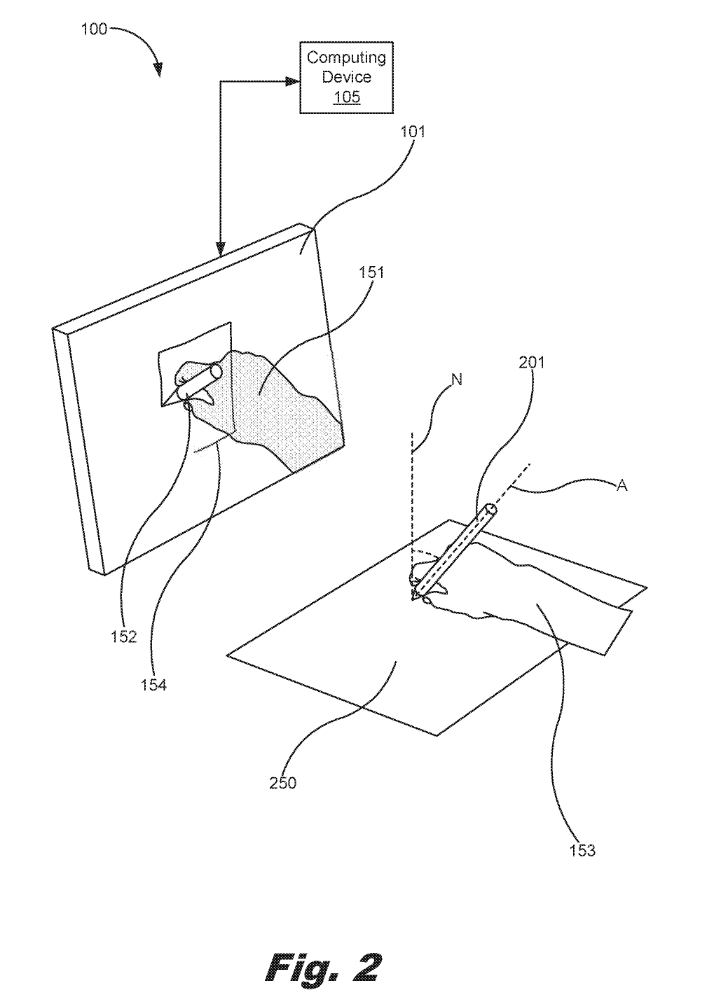

In another example, the input device (102) may include a stylus or other “dumb” input device and a tablet device that detects the position of the stylus as it is touched at a surface of the tablet device. The tablet device may then relay information regarding the location of the stylus on the tablet device to a computing device. This example may further include an image capture device that captures an image of the user's hand/arm, the input device, or combinations thereof as the input of the stylus at the tablet device is made. A representation of the input device (103), the hand of the user (104), or combinations thereof may be displayed on the display device (101) based on the information relayed by the tablet device and the image capture device. More details regarding these various devices and systems will now be described in connection with FIGS. 2 through 5.

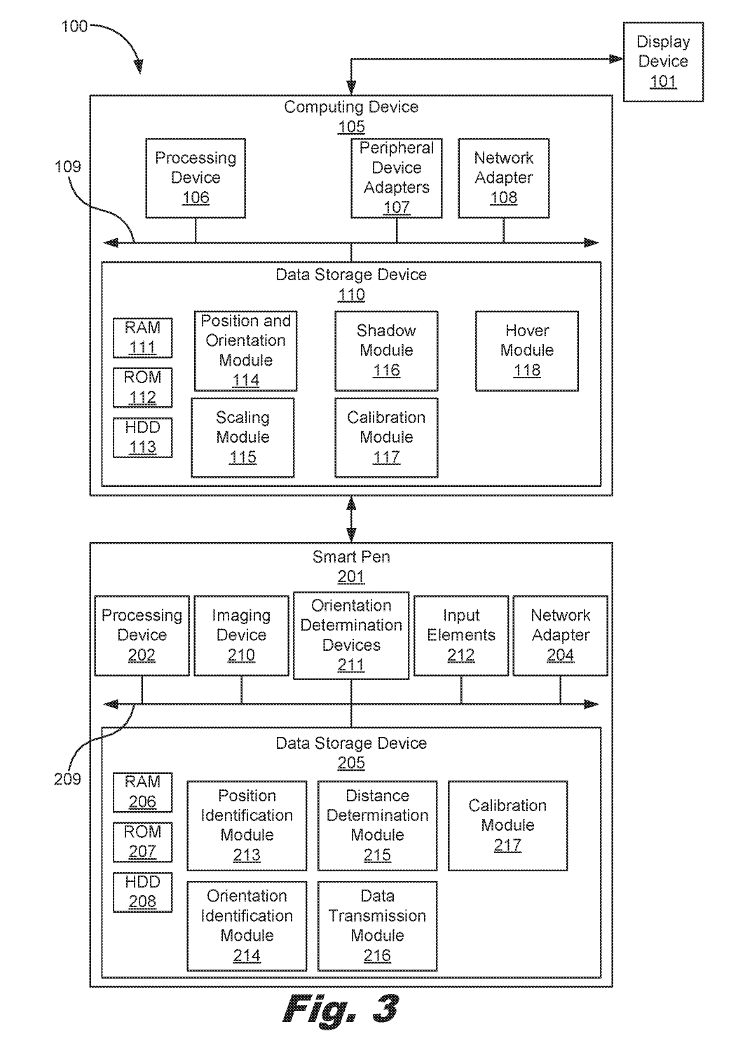

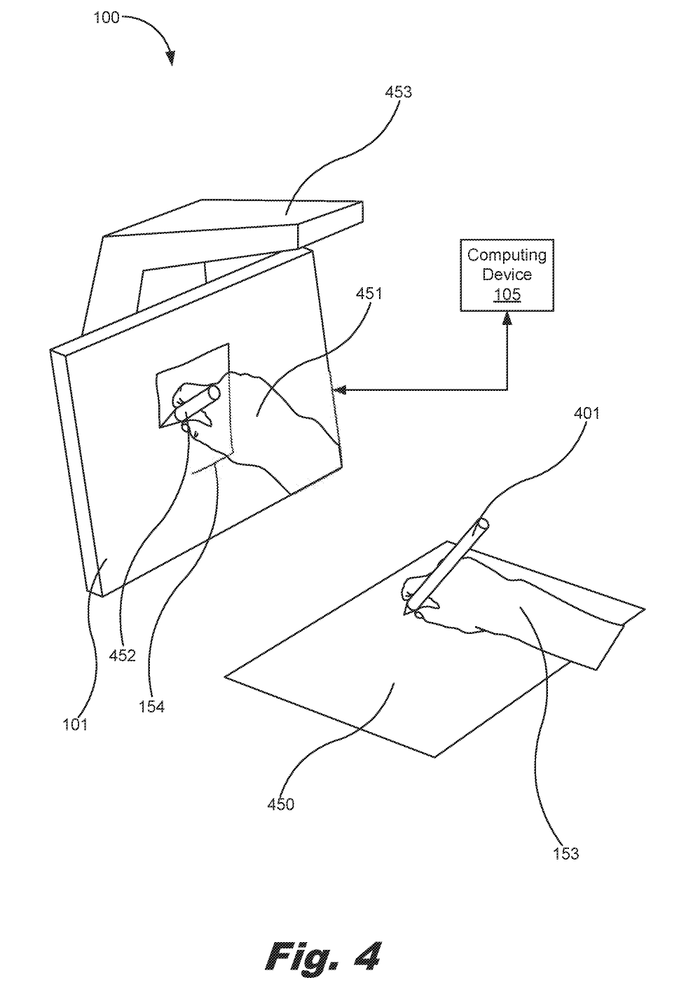

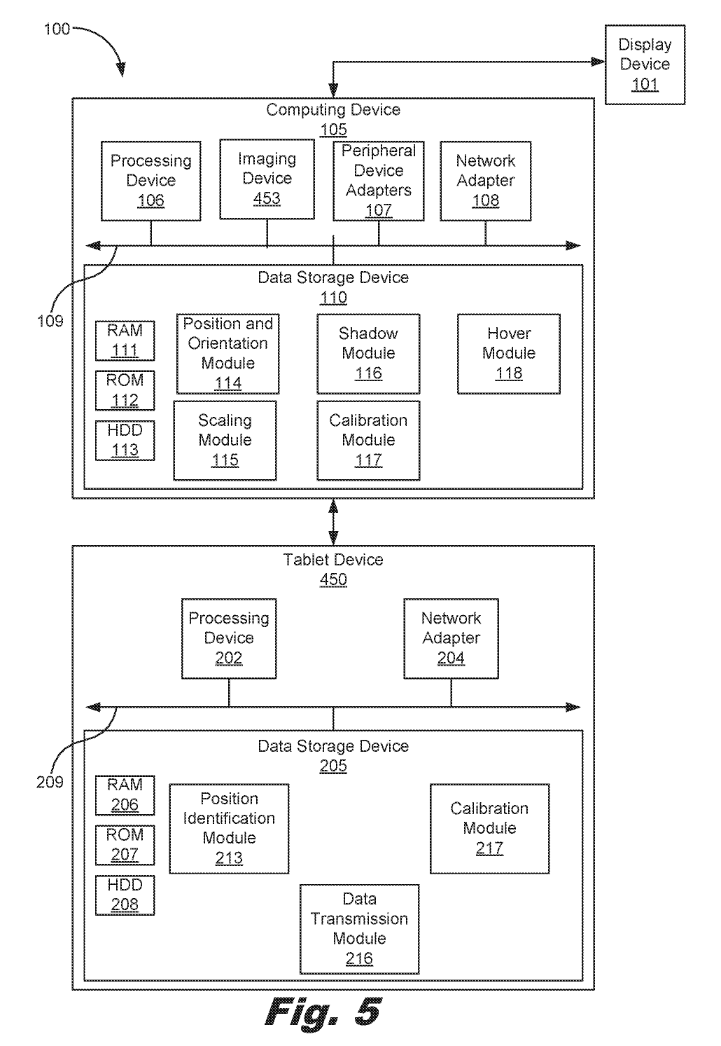

FIG. 2 is a diagram of a visual cue system (100), according to another example of the principles described herein. FIG. 3 is a block diagram of the visual cue system (100) of FIG. 2, according to one example of the principles described herein. FIGS. 2 and 3 will now be described together since they describe the same example of the visual cue system (100). Elements presented in connection with FIGS. 2 and 3 may be similar to elements presented in connection with FIGS. 4 and 5, and the description given here for FIGS. 2 and 3 apply similarly to similar elements in FIGS. 4 and 5.

The visual cue system (100) of FIGS. 2 and 3 may include a display device (101) coupled to a computing device (105), a smart pen (201), and a writing surface (250). The display device (101) may be any device that outputs data input to the computing device (105) via the smart pen (201) for presentation of the data in a visual form. Examples of display devices may include a liquid crystal display (LCD), a cathode ray tube (CRT), a plasma display device, and a touch screen display device, among other display device types, or combinations thereof. In another example, the display device (101) may also include a VR or AR system, other 3D output devices, projected displays, or combinations thereof. In one example, the various subcomponents or elements of the visual cue system (100) may be embodied in a plurality of different systems, where different modules may be grouped or distributed across the plurality of different systems.

The writing surface (250) may be any surface that allows the smart pen (201) to identify and document its position relative to the writing surface (250). In one example, the writing surface (250) may include position identification markings that, in combination with a pattern reading capability of the smart pen, allow for the smart pen to identify positions with respect to the writing surface (250). Systems using this technology are available from, for example, Anoto AB and described on their website www.Anoto.com.

The computing device (105) may be implemented in an electronic device. Examples of electronic devices include servers, desktop computers, laptop computers, personal digital assistants (PDAs), mobile devices, smartphones, gaming systems, and tablets, among other electronic devices. The computing device (105) may be utilized in any data processing scenario including, stand-alone hardware, mobile applications, through a computing network, or combinations thereof. Further, the present systems may be implemented on one or multiple hardware platforms, in which the modules in the system can be executed on one or across multiple platforms. In another example, the methods provided by the visual cue system (100) are executed by a local administrator.

To achieve its desired functionality, the computing device (105) includes various hardware components. Among these hardware components may be a number of processing devices (106), a number of data storage devices (110), a number of peripheral device adapters (107), and a number of network adapters (108). These hardware components may be interconnected through the use of a number of busses and/or network connections. In one example, the processing devices (106), data storage device (110), peripheral device adapters (107), and network adapters (108) may be communicatively coupled via a bus (109).

The processing devices (106) may include the hardware architecture to retrieve executable code from the data storage device (110) and execute the executable code. The executable code may, when executed by the processing devices (106), cause the processing devices (106) to implement at least the functionality of receiving position and orientation data from the smart pen (201). The executable code may, when executed by the processing devices (106), also cause the processing devices (106) to display a representation (152) of the smart pen (201), and a representation (151) of a hand and/or arm (153) of the user on the display device (101). Still further, the executable code may, when executed by the processing devices (106), scale the size of the representation of the smart pen (201), and a representation (151) of the hand and/or arm (153) of the user, and present the scaled the representation (151) of the smart pen (201) and a scaled representation (151) of the hand and/or arm (153) of the user on the display device (101).

Even still further, the executable code may, when executed by the processing devices (106), present the representation (151) of the hand and/or arm (153) of the user on the display device (101) as a shadow hand where the shadow hand is represented based on orientation and position information obtained by the smart pen (201). Even still further, the executable code may, when executed by the processing devices (106), calibrate position and movement of the smart pen (201). Even still further, the executable code may, when executed by the processing devices (106), detect a hover state of the smart pen above the writing surface (250), and represent the hover state of the smart pen (201) on the display device (101). The processing device (106) functions according to the systems and methods described herein. In the course of executing code, the processing device (106) may receive input from and provide output to a number of the remaining hardware units.

The data storage device (110) and other data storage devices described herein may store data such as executable program code that is executed by the processing device (106). As will be discussed, the data storage device (110) may specifically store computer code representing a number of applications that the processing devices (106) executes to implement at least the functionality described herein.

The data storage device (110) and other data storage devices described herein may include various types of memory modules, including volatile and nonvolatile memory. For example, the data storage device (110) of the present example includes Random Access Memory (RAM) (111), Read Only Memory (ROM) (112), and Hard Disk Drive (HDD) memory (113). Many other types of memory may also be utilized, and the present specification contemplates the use of many varying type(s) of memory in the data storage device (110) as may suit a particular application of the principles described herein. In certain examples, different types of memory in the data storage device (110) may be used for different data storage needs. For example, in certain examples the processing device (106) may boot from Read Only Memory (ROM) (112), maintain nonvolatile storage in the Hard Disk Drive (HDD) memory (113), and execute program code stored in Random Access Memory (RAM) (111).

The data storage device (110) and other data storage devices described herein may include a computer readable medium, a computer readable storage medium, or a non-transitory computer readable medium, among others. For example, the data storage device (110) may be, but not limited to, an electronic, magnetic, optical, electromagnetic, infrared, or semiconductor system, apparatus, or device, or any suitable combination of the foregoing. More specific examples of the computer readable storage medium may include, for example, the following: an electrical connection having a number of wires, a portable computer diskette, a hard disk, a random access memory (RAM), a read-only memory (ROM), an erasable programmable read-only memory (EPROM or Flash memory), a portable compact disc read-only memory (CD-ROM), an optical storage device, a magnetic storage device, or any suitable combination of the foregoing. In the context of this document, a computer readable storage medium may be any tangible medium that can contain, or store computer usable program code for use by or in connection with an instruction execution system, apparatus, or device. In another example, a computer readable storage medium may be any non-transitory medium that can contain, or store a program for use by or in connection with an instruction execution system, apparatus, or device.

The hardware adapters (107, 108) in the computing device (105) enable the processing device (106) to interface with various other hardware elements, external and internal to the computing device (105). For example, the peripheral device adapters (107) may provide an interface to input/output devices, such as, for example, display device (101), a mouse, or a keyboard. The peripheral device adapters (107) may also provide access to other external devices such as an external storage device, a number of network devices such as, for example, servers, switches, and routers, client devices, other types of computing devices, and combinations thereof. The peripheral device adapters (107) may also create an interface between the processing device (106) and the display device (101), a printer, or other media output devices. The network adapter (108) may provide an interface to other computing devices within, for example, a network, thereby enabling the transmission of data between the computing device (105) and other devices located within the network.

The computing device (105) may further include a number of modules used in the implementation of the systems and methods described herein. The various modules within the computing device (105) include executable program code that may be executed separately. In this example, the various modules may be stored as separate computer program products. In another example, the various modules within the computing device (105) may be combined within a number of computer program products; each computer program product including a number of the modules.

The computing device (105) may include a position and orientation module (114) to, when executed by the processing device (106), obtain position and orientation data from the smart pen (201), create and display a representation (152) of the smart pen (201), and a representation (151) and the hand and/or arm (153) of the user on the display device (101). The creation of the representations (151, 152) includes creation of the representations (151, 152) as new position and orientation data from the smart pen (201) is available. In this manner, the representations (151, 152) are continually displayed and provide motion to the representation (151, 152) such that as the user moves his or her hand and/or arm (153), the representation (152) of the smart pen (201), and the representation (151) and the hand and/or arm (153) of the user moves as well. This allows the user to obtain visual feedback regarding the position of the smart pen (201) relative to the writing surface (250) and how that position translates to its corresponding representation (151, 152) on the display device (101). This also allows the user to obtain visual feedback regarding a translation of a speed of movement of the smart pen (201) relative to the writing surface (250) and how that speed of movement translates to its corresponding representation (151, 152) on the display device (101). Further, this allows the user to obtain visual feedback regarding an orientation of the smart pen (201) relative to the writing surface (250) and how that orientation translates to its corresponding representation (151, 152) on the display device (101).

The computing device (105) may also include a scaling module (115) to, when executed by the processing device (106), scale the size of the representation (152) of the smart pen (201), and the representation (151) of the hand and/or arm (153) of the user. The scaling module (115) also presents the scaled the representations (151, 152) on the display device (101). This provides the user with the ability to understand the proportions of images (154) created in a workspace of the display device (101) relative to their own arm and/or hand (153). The scaling module (115) may also assist in scaling and mapping the input surface such as the writing substrate (250) to the display device (101) in order the provide the user with an understanding and sense of for how an input motion with the input device translates into a stroke of a certain length in the workspace presented on the display device (101). For example, if a mapping of the writing substrate (250) to the display device (101) is 1:1, then the representations (151, 152) may be presented at a life-sized proportion, whereas if a small motion of the smart pen (201) resulted in a larger motion in the workspace of the display device (101), then the representations (151, 152) are magnified proportionately. In one example, the scaling may be user-defined such that the user may adjust the proportions of the representations (151, 152).

Further, the computing device (105) may also include a shadow module (116) to, when executed by the processing device (106), present the representations (151, 152) as a shadow hand where the shadow hand is represented based on orientation and position information obtained by the smart pen (201). In one example, the shadow hand (151) is a computer modeled and generated image of the user's hand and/or arm (153), and may include a level of transparency less than completely opaque and greater than completely transparent. In another example, the representation (152) of the smart pen (201) may also be presented using the shadow module (116) to allow for a level of transparency to exists with respect to the representation (152) of the smart pen (201) as well. Providing the shadow hand (151), the representation (152) of the smart pen (201), or combinations thereof in at least a partially transparent form serves to not occlude images (154) displayed on the display device (101) that were either created by the user through use of the smart pen (201) or otherwise displayed by the computing device (105) on the display device (101). This allows a user to see what images (154) are displayed without having to move the smart pen (201) while still providing the visual feedback provided by the representations (151, 152). In one example, the transparency of the representations (151, 152) may be user-defined such that the user may adjust the level of transparency of the representations (151, 152) as displayed on the display device (101).

The computing device (105) may also include a calibration module (117) to, when executed by the processing device (106), calibrate movement of the smart pen (201). In one example, calibration may occur between the smart pen (201) and the computing device (105) so that positions, orientations, speeds of movement, and other information regarding the movement of the smart pen (201) relative to the writing substrate (250) and how this movement translates to movement of the representations (151, 152) on the display device (101) are aligned and synchronized. Calibration may include, in one example, instructing the user to make a number of motions with his or her arm and/or hand (153) with the smart pen (201) in their grasp. These instructions may include, for example, instructing the user to keeping his or her forearm extended straight at the screen, drawing a line on the input surface, tracing a line segment displayed on the display device from one point to another. The instructions may further include tracing a line segment, and when the user reaches the end of the line segment stopping and, keeping the pen at the end of the line segment, check to see which of a number of images most closely matches the user's arm and/or hand pose. This type of calibration causes the representations (151, 152) to have a more natural and precisely similar look with respect to the user's arm and/or hand (153).

Even still further, the computing device (105) may also include a hover module (118) to, when executed by the processing device (106), detect a hover state of the smart pen (201) above the writing surface (250), and represent the hover state of the smart pen (201) on the display device (101). A hover state may be represented and displayed on the display device (101) using a number of visual changes to the representation (152) of the smart pen (201) and the representation (151) of the hand and/or arm (153). The changes may include, for example, a change in transparency, size, color, shade, shading, contrast, blurring (e.g., Gaussian blurring), an addition of shadowing beneath the representations (151, 152), an appearance and variance in size of a drop shadow beneath the representations (151, 152), other forms of changes to visual aspects of the representations (151, 152), a change in transparency of the representation (151) of the hand and/or arm (153) as distance increases between the input device (201) and the hand and/or arm (153), or combinations thereof. In one example, the smart pen (201) or other input device may be aware of its proximity to the writing substrate (250) or another surface. In this example, that data obtained may be used by the computing device (105) to present the changes to the representations (151, 152) as the hover distance changes. Further, in one example, the visual changes to the representation (152) of the smart pen (201) and the representation (151) of the hand and/or arm (153) may be at least partially based on calibration information obtained from the calibration module (117) and a number of sensors within the smart pen (201), a tablet device (FIG. 4, 450), an imaging device, or other input device.

The smart pen (201) will now be described in connection with FIGS. 2 and 3. The smart pen (201) may be implemented in an electronic device, and may be utilized in any data processing scenario including, stand-alone hardware, mobile applications, through a computing network, or combinations thereof.

To achieve its desired functionality, the smart pen (201) includes various hardware components. Among these hardware components may be a number of processing devices (202), a number of data storage devices (205), and a number of network adapters (204). These hardware components may be interconnected through the use of a number of busses and/or network connections. In one example, the processing devices (202), data storage device (205), and network adapters (204) may be communicatively coupled via a bus (209).

The processing devices (202) may include the hardware architecture to retrieve executable code from the data storage device (205) and execute the executable code. The executable code may, when executed by the processing devices (202), cause the processing devices (202) to implement at least the functionality of identifying, via an included imaging device (210), a position of the smart pen (201) relative to the writing substrate (250). Further, the executable code may, when executed by the processing devices (202), cause the processing devices (202) to identify an orientation of the smart pen (201) using, for example, a number of orientation determination devices (211) included in the smart pen (201). Still further, the executable code may, when executed by the processing devices (202), cause the processing devices (202) to identify, via the imaging device, a distance of the smart pen (201) from the writing substrate (250) or a hover state of the smart pen (201) relative to the writing substrate (250). Even still further, the executable code may, when executed by the processing devices (202), cause the processing devices (202) to send the smart pen (201) position and orientation data to the computing device (105) through the use of the network adaptor (204). Even still further, the executable code may, when executed by the processing devices (106), calibrate position and movement of the smart pen (201) with the computing device (105). The processing device (202) functions according to the systems and methods described herein. In the course of executing code, the processing device (202) may receive input from and provide output to a number of the remaining hardware units.

As will be discussed, the data storage device (205) may specifically store computer code representing a number of applications that the processing device (202) executes to implement at least the functionality described herein.

The data storage device (205) may include Random Access Memory (RAM) (206), Read Only Memory (ROM) (207), and Hard Disk Drive (HDD) memory (208). Many other types of memory may also be utilized, and the present specification contemplates the use of many varying type(s) of memory in the data storage device (205) as may suit a particular application of the principles described herein. In certain examples, different types of memory in the data storage device (205) may be used for different data storage needs. For example, in certain examples the processing device (202) may boot from Read Only Memory (ROM) (207), maintain nonvolatile storage in the Hard Disk Drive (HDD) memory (208), and execute program code stored in Random Access Memory (RAM) (206).

Hardware adapters (204) in the smart pen (201) enable the processing device (202) to interface with various other hardware elements, external and internal to the smart pen (201). The network adapter (204) may provide an interface to other computing devices within, for example, a network, and including the computing device (105), thereby enabling the transmission of data between the smart pen (201) and other devices located within the network. The network adaptor (204) may use any number of wired or wireless communications technologies in communicating with the computing device (105). Examples of wireless communication technologies include, for example, satellite communications, cellular communications, radio communications such under the IEEE 802.11 standards, wireless personal area network (PAN) technologies such as BLUETOOTH developed and distributed by the Bluetooth Special Interest Group, wireless area networks (WAN), among other wireless technologies.

The imaging device (210) of the smart pen (201) may be any device that captures a number of images of the surrounding environment of the smart pen (201) including, for example, portions of the writing substrate (250). In one example, the imaging device (210) is an infrared imaging device. In one example, the imaging device (210) is a live video capture device that captures video of the surrounding environment. The smart pen (201) may then transmit the video to the computing device (105) for processing and display on the display device (101) as described herein.

In one example, the imaging device (210) may be arranged to image a small area of the writing substrate (250) close to a nib of the smart pen (201). The processing device (202) of the smart pen (201) includes image processing capabilities and the data storage device (205), and may detect the positioning of the position identification markings on the writing surface (250). This, in combination with a pattern reading capability of the smart pen (201), allow for the smart pen to identify positions with respect to the writing surface (250). Further, the identification markings on the writing surface (250) may also assist in determining the tilt angle of the smart pen (201) relative to the writing substrate (250). In one example, the imaging device (210) may be activated by a force sensor in the nib to record images from the imaging device (210) as the smart pen (201) is moved across the writing substrate (250). From the captured images, the smart pen (201) determines the position of the smart pen (201) relative to the writing substrate (250), and a distance of the smart pen (201) from the writing substrate (250). Movements of the smart pen (201) relative to the writing substrate (250) may be stored directly as graphic images in the data storage device (205), may be buffered in the data storage device (205) before sending the data onto the computing device (105), may be sent to the computing device as soon as it is captured by the imaging device (210), or combinations thereof.

A number of orientation determination devices (211) may be included in the smart pen (201) as mentioned above. The orientation determination devices (211) may include, for example, gyroscopes, accelerometers, other orientation-determining devices, and combinations thereof, and may determine the tilt direction, tilt angle (A) from a normal (N) surface of the writing substrate (250), proper acceleration, rotation of the smart pen (201) about a longitudinal axis of the smart pen (201), other orientation information, and combinations thereof. The orientation determination devices (211) may output orientation data to the computing device (105) via the processing device (202) and network adapter (204) of the smart pen (201). Once received, the orientation data may be processed by the processing device (106) of the computing device (105) to create the representation (152) of the smart pen (201), and the representation (152) of the smart pen (201) may be displayed on the display device (101) including representation of an orientation of the representation (152) based on the orientation data.

The smart pen (201) may further include a number of input elements (212). In one example, the input elements (212) may be located on a surface of the smart pen (201). In one example, the input elements (212) may include a number of touch sensors located along the surface of the smart pen (201). In this example, the touch sensors may be used to detect locations and pressures used by the user in holding the smart pen (201) to create grip data. This type of data collected by the touch sensors may be sent to the computing device (105), and may be processed by the computing device (105) to assist in the creation and presentation of the representation (152) of the smart pen (201) and the representation (151) of the hand and/or arm (153) of the user on the display device (101). In this example, the representation (152) of the smart pen (201) may be created and displayed based on the grip data collected by the touch sensors.

In another example, the input elements may include a number of buttons located along a surface of the smart pen (201). The buttons may, when activated by the user, execute any number of commands. In one example, the representation (152) of the smart pen (201) may detailed enough to include the location of the input elements (212) along with details regarding which input elements are being activated in response to a user activating the input elements. In this manner, a user may refer to the representation (151) presented on the display device (101) rather than looking down at the actual smart pen (201) to identify the location of the buttons or other features of the smart pen (201).

In one example, a piezoelectric pressure sensor may also be included in a nib of the smart pen (201) that detects and measures pressure applied on the nib, and provides this information to the computing device (105). In this example, a representation of the pressure exerted on the smart pen (201) may be included in the representation (152) of the smart pen (201). For example, a color, color gradient, color spectrum, fill, or other visual indicator may move up the longitudinal axis of the representation (152) as more or less pressure is applied to the nib of the smart pen (201).

The smart pen (201) may further include a number of modules used in the implementation of the systems and methods described herein. The various modules within the smart pen (201) include executable program code that may be executed separately. In this example, the various modules may be stored as separate computer program products. In another example, the various modules within the smart pen (201) may be combined within a number of computer program products; each computer program product including a number of the modules.

The smart pen (201) may include a position identification module (213). When executed by the processing device (202), the position identification module (213) detects, through the imaging device (210), the position of the smart pen (201) relative to the writing substrate (250), and relays data representing the position of the smart pen (201) to the computing device (105) for processing by the position and orientation module (114).

The smart pen (201) may include an orientation identification module (214). The orientation identification module (214), when executed by the processing device (202), detects, through the orientation determination devices (211), an orientation of the smart pen (201) relative to normal (N) of the writing substrate (250), and relays data representing the orientation of the smart pen (201) to the computing device (105) for processing by the position and orientation module (114).

Still further, the smart pen (201) may include a distance determination module (215). When executed by the processing device (202), the distance determination module (215) may determine the distance of the smart pen (201) from a surface of the writing substrate (250) using the imaging device (210). In one example, the distance may be identified as a hover distance. As mentioned above, the distance from the surface of the writing substrate (250) or hover state may be used by the hover module (118) of the computing device (105) to make a number of changes to the representation (152) of the smart pen (201) and the representation (151) and the hand and/or arm (153) in order to provide a visual appearance of a movement of the smart pen (201) and the user's hand and/or arm (153) from the surface of the writing substrate (250). Further, in one example, the output of the distance determination module (215) may be used to determine when input from the smart pen (201) may be activated or deactivated based on the detected distance. This provides for unintentional inputs from the smart pen (201) to not be registered by the smart pen (201) or the computing device (105), and, conversely, allows for intentional smart pen (201) inputs to be registered.

Even still further, the smart pen (201) may include a data transmission module (216). The data transmission module (216), when executed by the processing device (202), sends data representing position, orientation, and distance information supplied by modules (213, 214, 215) to the computing device (105) as described herein using, for example, the network adapter (204). The computing device (105) processes this transmitted data in order to present the representations (151, 152) on the display device (101) with the representations (151, 152) tracking actual movements, positions, orientations, and distances of the smart pen (201) and the user's hand.

The smart pen (201) may also include a calibration module (217) to, when executed by the processing device (202), calibrate movement of the smart pen (201). As mentioned above, in one example, calibration may occur between the smart pen (201) and the computing device (105) so that positions, orientations, speeds of movement, and other information regarding the movement of the smart pen (201) relative to the writing substrate (250) and how this movement translates to movement of the representations (151, 152) on the display device (101) are aligned and synchronized. Thus, the calibration module (217) of the smart pen (201) and the calibration module (117) of the computing device (105) may work in concert to align and synchronize movements, positions, orientations, and distances of the smart pen (201) with movements, positions, orientations, and distances of the representations (151, 152). This type of calibration causes the representations (151, 152) to have a more natural and precisely similar look with respect to the user's arm and/or hand (153).

In one example, the calibration information obtained from the calibration module (117) may be used to alter the display of information on the display device (101) including, for example, scaling of the size of the representation of the smart pen (201), and a representation (151) of the hand and/or arm (153) of the user, altering shadowing that may be displayed in connection with the hand and/or arm (153) of the user, altering a point of view of elements displayed on the display device (101). These alterations based on the calibration information may be user-definable.

FIG. 4 is a diagram of a visual cue system (100), according to yet another example of the principles described herein. FIG. 5 is a block diagram of the visual cue system (100) of FIG. 4, according to one example of the principles described herein. The example of the visual cue system (100) in FIGS. 2 and 3 utilize a passive writing substrate (250) and an active input device in the form of a smart pen (201). In the example of the visual cue system (100) of FIGS. 4 and 5, however, a passive input device in the form of a stylus (401) and an active writing substrate in the form of a tablet device (450) are used. Further, in the example of FIGS. 4 and 5, the visual cue system (100) may include an imaging device (453) such as an overhead camera associated with the display device (101) and the computing device (105). In one example, the imaging device (453) may be or may be accompanied by a three-dimensional (3D) imaging device in order to provide real-time 3D visualization of, for example, the smart pen (201), the stylus (401), the hand and/or arm (153), or combinations thereof. More details regarding 3D imaging will be provided below. The elements identified in FIGS. 4 and 5 that are identically numbered in FIGS. 2 and 3 are identical elements within FIGS. 4 and 5, and are described above.

In FIG. 4, the user may utilize a stylus (401) to interact with a tablet device (450). The tablet device (450) may be any input device with which a user may interact with to give input or control the information processing system through a number of touch gestures by touching the screen with the stylus (401) and/or a number of fingers. In one example, the tablet device (450) may further function as an output device that also displays information via an electronic visual display. The tablet device (450) may be, for example, a touch screen computing device, a digitizing tablet, or other input device that enables the user to hand-draw images on a surface, and have those images represented on the display device (101).

The tablet device (450) is communicatively coupled to the computing device (105) using a wired or wireless connection. The computing device (105) may include a position and orientation module (114) to, when executed by the processing device (106), obtain position and orientation data from the imaging device (453). The images captured by the imaging device (453) are processed and a position and orientation of the stylus (401) is extracted from the captured images. The position and orientation of the stylus (401) may be presented on the display device (101) based on the extracted positions and orientations. In another example, in one example, a default tilt may be assumed with regard to the stylus (401), and the default tilt may be portrayed on the display device (101).

Further, the position and orientation module (114) also uses captured (2D or 3D) images of the user's hand and/or arm (153) to create a video overlay of the user's actual hand and/or arm (153). Thus, the stylus (401) and the user's actual hand and/or arm (153) are represented by the computing device (105) on the display device (101) as captured by the imaging device (453). In one example, the stylus (401) and the user's hand and/or arm (153) may be depicted at a level of transparency as described above in connection with the representation (151) of a hand and/or arm (153) in FIGS. 2 and 3. This allows a user to see what images (154) are displayed without having to move the stylus (401) or their hand and/or arm (153), while still providing the visual feedback provided by the representations (451, 452). In one example, the transparency of the representations (451, 452) may be user-defined such that the user may adjust the level of transparency of the representations (451, 452) as displayed on the display device (101).

The tablet device (450) may include touch sensors in its input surface. In one example, a user may touch his or fingers, palm, wrist or other portion of their hand and/or arm (153) to a portion of the input surface. In this example, the tablet device (450) may use these incidental touches of the hand and/or arm (153) as clues as to the user's palm and elbow positions. This information may be relayed to the computing device (105) and used to depict the representation (451) of the user's hand and/or arm (153).

Further, using the imaging device (453), the computing device (105) may be able to distinguish between an accidental touch of the user's hand and/or arm (153) to the tablet device (450) versus an intentional touch of the stylus (401) or the user's hand and/or arm (153) to the tablet device (450). In this example, the user may be making a motion towards the tablet device (450), and may accidentally touch a part of his or her hand and/or arm (153) to the tablet device (450). Because the imaging device (453) has captured the movement of the user's hand and/or arm (153) to the tablet device (450), the computing device knows that the accidental touch should be disregarded as any type of input attempt, and should wait until the stylus (401) reaches the surface of the tablet device (450). For example, if the computing device (105), using the imaging device (453), views the stylus (401) in the image of the users hand and/or arm (153) it may assume that an input from the stylus (401) is expected, and will disregard a touch input.

In one example, the representation (451) of the user's hand and/or arm (153) may be a processed version of the images captured by the imaging device (453). In this example, a silhouette of the user's hand and/or arm (153) may be displayed as the representation (451). In another example, an image of the stylus (401) and the user's hand and/or arm (153), may be synthesized from the images captured by the imaging device (453) and stylus (401) and incidental inputs received at the tablet device (450). Further, in one example, the visual cue system (100) of FIGS. 2 and 3 may also use the imaging device (453) depicted in FIGS. 4 and 5. In this example, the representations (151, 152) may be created or augmented using images captured from the imaging device (453). In this example, the visual cue system (100) may base the form of the representation (151) on orientation and position information obtained by the smart pen (201), an image captured by the imaging device (453), or a combination thereof.

As to the examples of FIGS. 2 through 5, the various inputs provided by the smart pen (201), stylus (401), tablet device (450), and imaging device (453), may be used to generate three-dimensional (3D) models of the smart pen (201), stylus (401), and the user's hand and/or arm (153). The 3D models may be processed and displayed by the computing device (105) to depict the representations (151, 152, 451, 452) of the smart pen (201), stylus (401), and the user's hand and/or arm (153) on the display device (101).

In another example, a generic 3D model of a user's hand and/or arm (153) may be presented with a representation (152, 452) of the smart pen (201) or stylus (401) where the generic 3D model is chosen by the user from a menu of options. In this example, the user may choose options in the 3D model that approximate his or her hand size, hand shape, left or right handedness, and grip relative to the smart pen (201) or stylus (401). An orientation and movement of the generic 3D model may be driven by preprogrammed animations associated with different orientations and motion trajectories of the smart pen (201) or stylus (401). In this example, arcs that correspond to pivoting motions of the user's wrist, elbow, or other joint may be recognized by the computing device (105), and the position of those body features of the user may be approximated in the representations (151, 152, 451, 452) of the smart pen (201), stylus (401), and the user's hand and/or arm (153) on the display device (101).

As to the examples of FIGS. 2 through 5, a number of 3D imaging device may be used to capture 3D images of the smart pen (201), stylus (401), and the user's hand and/or arm (153). In this example, the 3D data obtained may be processed by the computing device (105) and rendered on the display device (101) in order to assist the computing device (105) in generating the 3D models. In one example, the 3D imaging devices may include, for example, the KINECT 3D imaging system developed and distributed by the Microsoft corporation or a depth sensing camera developed and distributed by Leap Motion, Inc.

As to FIGS. 2 through 5, the examples described may also be applied in an augmented reality or virtual reality system where the smart pen (201) or the stylus (401) may be used to draw in space without the aid of a writing substrate (250) or a tablet device (450). Augmented reality is a live direct or indirect view of a physical, real-world environment whose elements are augmented by computer-generated sensory input such as sound, video, or graphics. Virtual reality is any computer technology that uses software to generate realistic images, sounds and other sensations that replicate an environment, and simulate a user's physical presence in the environment, by enabling the user to interact with this space and any objects depicted therein. In this example, a stereo 3D imaging system may be included in the visual cue systems (100) of FIGS. 2 through 5, and the visual cues including the representations (151, 152, 451, 452) may be presented to the user based on the user's movement within the AR or VR systems. In one example, the representations (151, 152, 451, 452) may be rendered as flat images, as 3D renderings, or combinations thereof. For example, a 3D representation of the smart pen (201) or the stylus (401) may be generated from the smart pen's (201) or the stylus's (401) own orientation data, and a 2D shadow hand may be associated with the 3D representation. In another example, a 3D imaging device may be used to generate a point cloud image of the user's hand and/or arm (153, 453) and the smart pen (201) or the stylus (401), which can then be registered with the virtual or augmented reality scene and inserted therein.

In the example described in FIGS. 2 through 5, a tip of the smart pen (201) or the stylus (401) may be specifically identified by the computing device (105) as presented on the display device (101). In one example, the tip of the smart pen (201) or the stylus (401) may be displayed in high contrast irrespective of a transparency level set for the representations (151, 152, 451, 452), for example. This allows a user to more readily see the actual position of the smart pen (201) or stylus (402) as represented on the display device (101).

A wearable sensor such as a smart watch worn on the user's wrist may be used in connection with the examples of FIGS. 2 through 5. If the smart watch or other device is worn on a drawing hand of the user, position, motion, and orientation information with respect to the smart pen (201) or the stylus (401) and other portions of the user's body may be obtained from the smart watch. This information may be used to assist in the rendering of the 3D model, and the display of the representations (151, 152, 451, 452) and their position, motion, and orientation on the display device (101). This provides for the rendering of more faithful representations (151, 152, 451, 452).

The input device (201, 401) may be represented as any tool in the workspace of the display device (101). For example, in FIGS. 2 through 5, a user may make a number of selections to switch between paint brushes, airbrushes, knives, pens, markers, or other tools within the workspace. When switching between these tools, the representation (252, 452) of the smart pen (201) and stylus (401) may change as well to a representation of a currently selected tool. For example, if a user wishes to switch from a pen-type input to a paint brush-type input, the representation (252, 452) of the smart pen (201) or stylus (401) may change from a pen to a paint brush. Further a user may select properties of the multiple tools such as size, shape, and color may change in the representation (252, 452) of the smart pen (201) or stylus (401) as these properties are selected.

In some examples, a docking station for the input device (201, 401) may be included in the visual cue system (100). The pen dock may serve as a location to store the input device (201, 401) and, in the case of the smart pen (201), electrically charge the input device. A representation of the docking station may be represented on the workspace of the display device (101). Using the visual feedback of the visual cue system (100), the user is able to place the input device (201, 401) into the docking station without looking at the docking station and relying on the visual cue of the position of the docking station presented on the display device (101). In this example, the location of the docking station relative to the input substrate (250, 450) may be sensed using an imaging device, or may be relayed by the docking station itself to the computing device (105) for display on the display device (101).

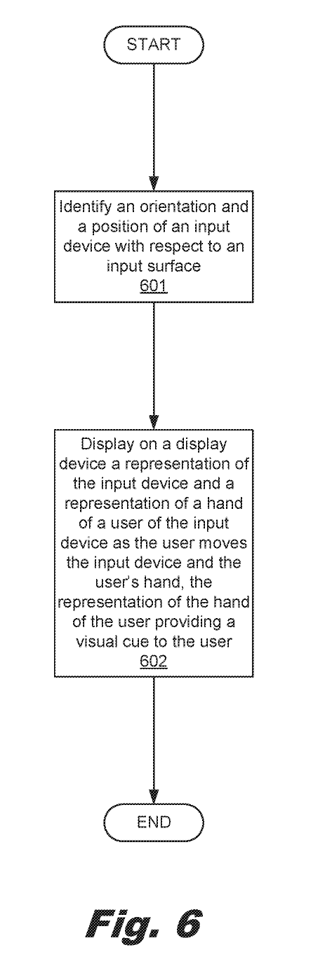

FIG. 6 is a flowchart depicting a method presenting a visual cue, according to one example of the principles described herein. The method of FIG. 6 may include identifying (block 601) an orientation and a position of an input device (201, 401) with respect to an input surface (250, 450). A representation (252, 452) of the input device (201, 401) and a representation (151, 451) of a hand (153) of a user of the input device (201, 401) is displayed (block 602) on a display device (101) as the user moves the input device (201, 401) and the user's hand (153). The representation (151, 451) of the hand (153) of the user provides a visual cue to the user.

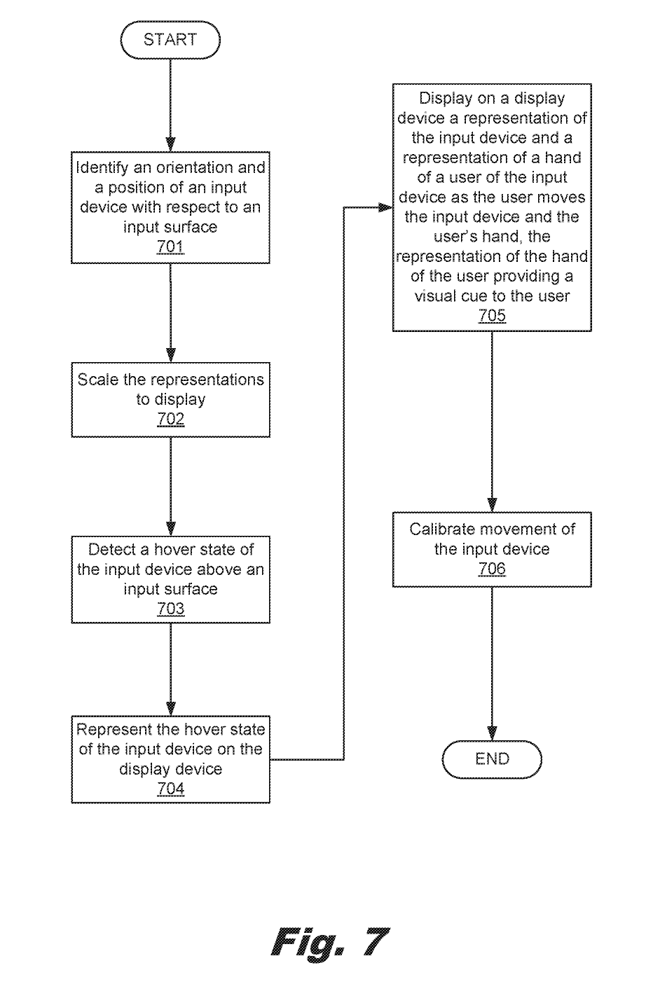

FIG. 7 is a flowchart depicting a method presenting a visual cue, according to another example of the principles described herein. The method of FIG. 7 is related to the systems of FIGS. 2 through 5, and may include identifying (block 701) an orientation and a position of an input device (201, 401) with respect to an input surface (250, 450). A representation (252, 452) of the input device (201, 401) and a representation (151, 451) of a hand (153) of a user may be scaled (block 702) to a display device (101) to provide visual feedback a user may feel comfortable with. As mentioned above, the scaling may be user-defined or adjusted by a user.

A hover state of the input device (201, 401) above an input surface (250, 450) may be detected (block 703) and represented (block 704) on the display device (101). A representation (252, 452) of the input device (201, 401) and a representation (151, 451) of a hand (153) of a user of the input device (201, 401) is displayed (block 705) on the display device (101) as the user moves the input device (201, 401) and the user's hand (153). The representation (151, 451) of the hand (153) of the user provides a visual cue to the user. Further, the method may include calibrating (block 706) movement of the input device (201, 401) relative to the representation (252, 452) of the input device (201, 401) presented on the display device (101).

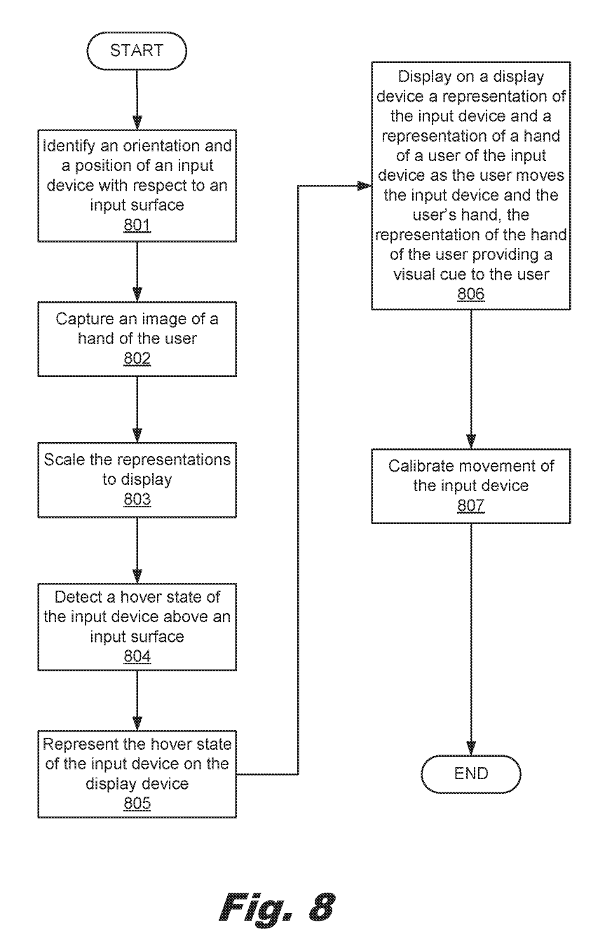

FIG. 8 is a flowchart depicting a method presenting a visual cue, according to yet another example of the principles described herein. The method of FIG. 8 is related to the systems of FIGS. 4 and 5, and may include identifying (block 801) an orientation and a position of an input device (201, 401) with respect to an input surface (250, 450). This orientation information may be provided by capturing an image of the input device (201, 401) with an imaging device (453). An image of the hand and/or arm (153) of the user may also be captured (block 802) using the imaging device (453).

A representation (252, 452) of the input device (201, 401) and a representation (151, 451) of a hand (153) of a user may be scaled (block 803) to a display device (101) to provide visual feedback a user may feel comfortable with. A hover state of the input device (201, 401) above an input surface (250, 450) may be detected (block 804) and represented (block 805) on the display device (101). A representation (252, 452) of the input device (201, 401) and a representation (151, 451) of a hand (153) of a user of the input device (201, 401) is displayed (block 806) on the display device (101) as the user moves the input device (201, 401) and the user's hand (153). The representation (151, 451) of the hand (153) of the user provides a visual cue to the user. Further, the method may include calibrating (block 807) movement of the input device (201, 401) relative to the representation (252, 452) of the input device (201, 401) presented on the display device (101).

Aspects of the present system and method are described herein with reference to flowchart illustrations and/or block diagrams of methods, apparatus (systems) and computer program products according to examples of the principles described herein. Each block of the flowchart illustrations and block diagrams, and combinations of blocks in the flowchart illustrations and block diagrams, may be implemented by computer usable program code. The computer usable program code may be provided to a processor of a general purpose computer, special purpose computer, or other programmable data processing apparatus to produce a machine, such that the computer usable program code, when executed via, for example, the processing devices (106, 202) or other programmable data processing apparatus, implement the functions or acts specified in the flowchart and/or block diagram block or blocks. In one example, the computer usable program code may be embodied within a computer readable storage medium; the computer readable storage medium being part of the computer program product. In one example, the computer readable storage medium is a non-transitory computer readable medium.

The specification and figures describe a visual cue system and associated methods. The visual cue system includes an input device, and a display device communicatively coupled to the input device to present a representation of the input device and a representation of a hand of a user of the input device as the user moves the input device and the user's hand. The representation of the hand of the user provides a visual cue to the user. This visual cue system provides for an intuitive indirect input system that provides feedback to a user.

The preceding description has been presented to illustrate and describe examples of the principles described. This description is not intended to be exhaustive or to limit these principles to any precise form disclosed. Many modifications and variations are possible in light of the above teaching.

What is claimed is:

1. A visual cue system comprising:
an input device; and
a display device communicatively coupled to the input device to present a representation of the input device and a representation of a hand of a user of the input device as the user moves the input device and the user's hand, the representation of the hand of the user providing a visual cue to the user.

2. The visual cue system of claim 1, wherein the input device comprises:
smart pen; and
a substrate comprising elements recognizable by the smart pen to identify position and orientation of the smart pen with respect to the substrate.

3. The visual cue system of claim 1, wherein the representation of the hand of the user is presented based on an orientation of the input device and the position of the input device relative to a substrate, wherein the input device communicates the orientation and position information to the display device.

4. The visual cue system of claim 1, wherein the representation of the hand of the user is presented on the display device as a shadow hand, the shadow hand being represented based on orientation and position information obtained by the input device.

5. The visual cue system of claim 1, wherein the input device comprises:
a stylus; and
a tablet device communicatively coupled to the display device.

6. The visual cue system of claim 1, further comprising an image capture device to capture an image of the hand of the user, wherein the representation of the hand of the user presented on the display device comprises a video overlay of the user's hand.

7. The visual cue system of claim 1, wherein the representation of the hand of the user is rendered at least partially transparent to not occlude objects displayed on the display device.

8. The visual cue system of claim 8, wherein a degree of transparency of the representation of the hand of the user is user-definable.

9. An indirect input user interface for presenting visual cues comprising:
an input surface;
an input device to interact with the input surface, the interaction between the input device and the input surface defining an orientation and a position of the input device with respect to the input surface; and
a display device communicatively coupled to the input device and the input surface wherein the display device presents a representation of the input device and a representation of a hand of a user of the input device as the user moves the input device and the user's hand, the representation of the hand of the user providing a visual cue to the user.

10. The indirect input user interface of claim 9, wherein input to the input surface is performed on a different visual plane relative to a visual plane of the display device.

11. The indirect input user interface of claim 9, wherein the representation of the hand of the user is rendered at least partially transparent to not occlude objects displayed on the display device.

12. A computer program product for presenting a visual cue, the computer program product comprising:
a non-transitory computer readable medium comprising computer usable program code embodied therewith, the computer usable program code to, when executed by a processor:
identify an orientation and a position of an input device with respect to an input surface; and
display on a display device a representation of the input device and a representation of a hand of a user of the input device as the user moves the input device and the user's hand, the representation of the hand of the user providing a visual cue to the user.

13. The computer program product of claim 12, further comprising computer usable program code to, when executed by the processor, calibrate movement of the input device.

14. The computer program product of claim 12, further comprising computer usable program code to, when executed by the processor, scale the representation of the hand of the user to display.

15. The computer program product of claim 12, further comprising computer usable program code to, when executed by the processor:
detect a hover state of the input device above an input surface; and
represent the hover state of the input device on the display device.
